(19) United States
(12) Patent Application Publication
(10) Pub. No.: US 2008/0219016 A1
(43) Pub. Date: Sep. 11, 2008

(54) AUTOMOBILE SEAT LIGHT FOR REAR COMPARTMENT LIGHTING

(76) Inventor: David R. Koliba, Macomb, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/682,441

(22) Filed: Mar. 6, 2007

(51) Int. Cl. B60Q 1/00

(52) U.S. Cl. 362/488

(57) ABSTRACT

The present invention provides a light located in a carved out portion of the front seat back in an automobile. In an exemplary embodiment, the light includes a light-emitting diode (LED) lamp attached to the top ledge that the carved out portion creates. This LED lamp is small in nature, and therefore hidden from the view of passengers and out of the way as to not interfere with the front seat back. Additional exemplary embodiments can include incandescent lamps, fluorescent lamps, and the like. Advantageously, the light in the carved out portion can be utilized as a courtesy lamp, a reading lamp, a map pocket lamp, and the like. Additionally, the present invention is designed to allow illumination while the automobile is operating without interference with the driver or neighboring automobiles by positioning the light such that the light angles downward while on.

### FIELD OF THE INVENTION

The present invention relates generally to lighting within the passenger compartment of an automobile, and more particularly to a light disposed within a recess portion on the rear surface of front seats in an automobile.

### BACKGROUND OF THE INVENTION

In automobiles, it would be advantageous to include lighting for the rear compartment which can illuminate while the automobile is in operation and not interfere with the driver and neighboring automobiles. Further, it would be advantageous to include lighting that is fixed in the rear compartment, i.e., not requiring a user to retract or rotate the light for operation.

U.S. Pat. No. 6,428,096 to Reitze discloses a rotatable light located in a backrest of an automobile seat. Disadvantageously, the Reitze reference requires the light to be fully rotated out of a recess in the automobile seat prior to operation. This requires a user to physically rotate the light for operation which could result in burning if the light is hot, or could lead to mechanical fatigue and failure based on repeated physical rotation of the light. Thus, a rear compartment light is needed which overcomes these limitations.

### BRIEF SUMMARY OF THE INVENTION

In various exemplary embodiments, the present invention provides a light disposed within a recess portion on the rear surface of front seats in an automobile. The recess portion covers an area representing the majority of the seat extending substantially from the bottom to the top of the rear surface of the seat. Further, the recess portion defines a top planar surface within which the light is disposed in an exemplary embodiment. In an exemplary embodiment, the light includes a light-emitting diode (LED) lamp attached to the top ledge that the carved out portion creates. This LED lamp is small in nature, and therefore hidden from the view of passengers and out of the way as to not interfere with the front seat back. Additional exemplary embodiments can include incandescent lamps, fluorescent lamps, and the like. Advantageously, the light can be utilized as a courtesy lamp, a reading lamp, a map pocket lamp, ambience, and the like. Additionally, the present invention is designed to allow illumination while the automobile is operating without interference with the driver or neighboring automobiles by positioning the light such that the light angles downward while on.

In an exemplary embodiment of the present invention, an automobile seat includes a seat back including a recess portion defined within the rear surface of the seat back, wherein the recess portion covers an area that represents the majority of the seat back, and the recess portion extends substantially from the seat back bottom to the seat back top, and a light attacked to a top planar surface of the recess portion. The automobile seat further includes a pocket disposed within the recess portion. Optionally, the automobile seat further includes a switch located on the rear side of the seat back, wherein the switch is configured to turn the light on and off. In one embodiment, the light includes a light emitting diode lamp. The light emitting diode lamp includes a lens operable to change the color of the light emitting diode lamp. In one embodiment, the light includes one of an incandescent lamp, fluorescent lamp, and light emitting diode lamp. The light is angled substantially downward with respect to the seat back. Optionally, the light is hard wired into automobile courtesy lamp circuits, and the light is dimmable. Alternatively, the light is wired into automobile courtesy lamp circuits with a switchable circuit. The recess portion is formed with a hard plastic shell.

In another exemplary embodiment of the present invention, an automobile seat light operable for rear compartment lighting includes a seat back including a recess portion defined within the rear surface of the seat back, wherein the recess portion covers an area that represents the majority of the seat back, and the recess portion extends substantially from the seat back bottom to the seat back top, and a light emitting diode lamp attached to a top planar surface of the recess portion, wherein the lamp is fixed in position inside the recess portion hidden from view, and wherein the lamp includes a lens operable to change the color of light emitted from the lamp, wherein the light is hard wired into automobile courtesy lamp circuits. Optionally, the light is hard wired into automobile courtesy lamp circuits, and the light is dimmable. Alternatively, the light is wired into automobile courtesy lamp circuits with a switchable circuit. The light is angled substantially downward with respect to the seat back.

In yet another exemplary embodiment of the present invention, an automobile seat light operable for rear compartment lighting includes a head rest, and a light emitting diode lamp attached disposed within the head rest and angled downward to a seat base on a rear seat, wherein the lamp is fixed in position, and wherein the lamp includes a lens operable to change the color of light emitted from the lamp.

### BRIEF DESCRIPTION OF THE DRAWINGS

The present invention is illustrated and described herein with reference to the various drawings, in which like reference numbers denote like method steps and/or system components, respectively, and in which:

FIG. 1 illustrates an automobile including an exemplary embodiment of the rear compartment seat light of the present invention.

FIG. 2 illustrates a top view of an exemplary embodiment of the rear compartment seat light of the present invention.

FIG. 3 illustrates a side view of front and rear seats including an exemplary embodiment of the rear compartment seat light of the present invention.

FIG. 4 illustrates another side view of front and rear seats including an exemplary embodiment of the rear compartment seat light of the present invention.

### DETAILED DESCRIPTION OF THE INVENTION

In various exemplary embodiments, the present invention provides a light disposed within a recess portion on the rear surface of front seats in an automobile. The recess portion covers an area representing the majority of the seat extending substantially from the bottom to the top of the rear surface of the seat. Further, the recess portion defines a top planar surface within which the light is disposed in an exemplary embodiment. In an exemplary embodiment, the light includes a light-emitting diode (LED) lamp attached to the top ledge that the carved out portion creates. This LED lamp is small in nature, and therefore hidden from the view of passengers and out of the way as to not interfere with the front seat back. Additional exemplary embodiments can include incandescent lamps, fluorescent lamps, and the like. Advantageously, the light can be utilized as a courtesy lamp, a reading lamp, a map pocket lamp, ambience, and the like. Additionally, the present invention is designed to allow illumination while the automobile is operating without interference with the driver or neighboring automobiles by positioning the light such that the light angles downward while on.

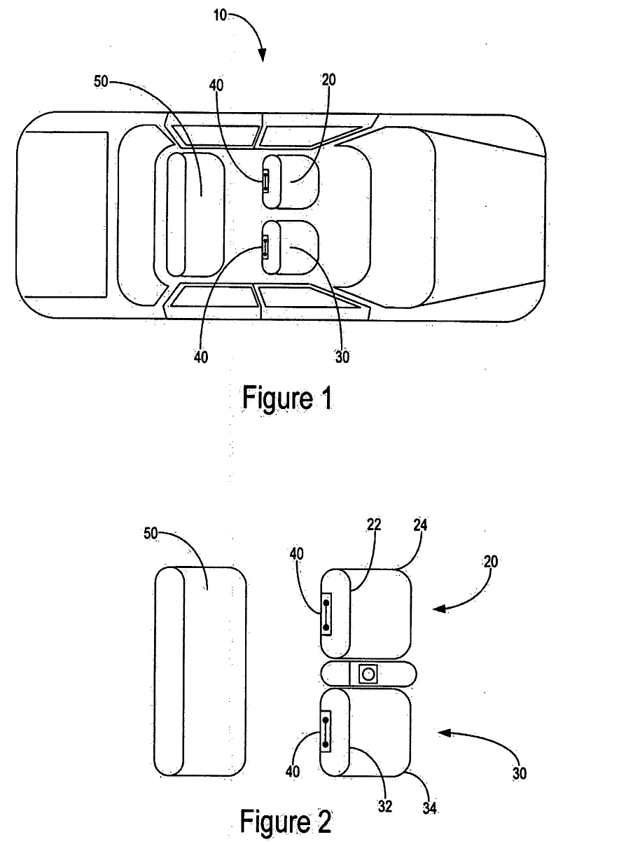

Referring to FIGS. 1 through 4, an automobile 10 includes a driver's seat 20, a passenger's seat 30, and a rear seat 50. The automobile 10 can include a two-door or four-door vehicle, such as a sedan, hatch-back, sport utility vehicle (SUV), mini-van, truck, or the like. The present invention can be utilized in any automobile 10 which includes both front seats 20 and 30 and a rear seat 50.

The driver's seat 20 includes a seat back 22 and a seat base 24, and the passenger's seat 30 includes a seat back 32 and a seat base 34. A driver and passenger physically sit on the seat bases 24 and 34, and the backs 22 and 32 provide back support for the driver and passenger. The seats 20 and 30, seat backs 22 and 32, and seat bases 24 and 34 can be adjustable to a variety of positions, such as seat 20 and 30 height, seat 20 and 30 depth, fore-and-aft position, seat back 22 and 32 angle, and the like. Further, seats 20 and 30 can include other components such as headrests 60, armrests, and the like.

To provide passengers in the rear seat 50 additional room, seat backs 22 and 32 can each include a recess portion 36 defined within the rear surface of the seat backs 22 and 32. The recess portion 36 covers an area that represents the majority of the seat backs 22 and 32, extending substantially from the seat back 22 and 32 bottom just above the seat base 24 and 34 to the seat back 22 and 32 top just below the headrest 60. For example, the recess portion 36 can be formed by a hard plastic shell on the rear of the seat backs 22 and 32. In addition to leg room, a pocket 38 can also be disposed within the recess portion. The pocket 38 can be a variety of sizes and materials as are known to those of ordinary skill in the art, and can be used for storage, such as for maps and the like.

In an exemplary embodiment of the present invention, a lamp 40 is attached to a top planar surface of the recess portion 36. Advantageously, the lamp 40 is hidden from the passenger's view. Additionally, the lamp 40 is fixed in position in the recess portion 36. Since the lamp 40 is located in the recess portion 36, it does not interfere with the seat backs 22 and 32 during adjustment. In another exemplary embodiment, the lamp 40 can be located within the headrest 60.

The lamp 40 can turn on and off through a small on/off switch mounted to the same hard shell ledge in the recess portion 36. Alternatively, the lamp 40 can turn on and off as a courtesy lamp by hard wiring the lamp into courtesy lamp circuits. Also, the lamp 40 can be wired into the courtesy lamp circuits with a switchable circuit. For example, the lamp 40 can turn on and off based on the opening and closing of the door. Further, the lamp 40 can be dimmable in the automobile 10 as is typical with courtesy lamps. For example, when the seat backs 22 and 32 are dumped and moved forward (e.g., an automobile 10 can include a 12 degree dump angle) for ingress or egress to the rear seat 50 as is done in a two-door automobile, the lamps 40 can be used to light the sill, floor, and top of rear seat 50.

The lamp 40 can include a LED lamp, incandescent lamp, fluorescent lamp, or the like. LED lamps have a long lifetime, and are more mechanically robust than incandescent or fluorescent lamps. Also, LED lamps can be configured to a color to match the vehicle's interior, or can include a changeable lens color matched to the vehicle interior. In other exemplary embodiments, a replaceable incandescent lamp can be used, and this provides a lower cost solution.

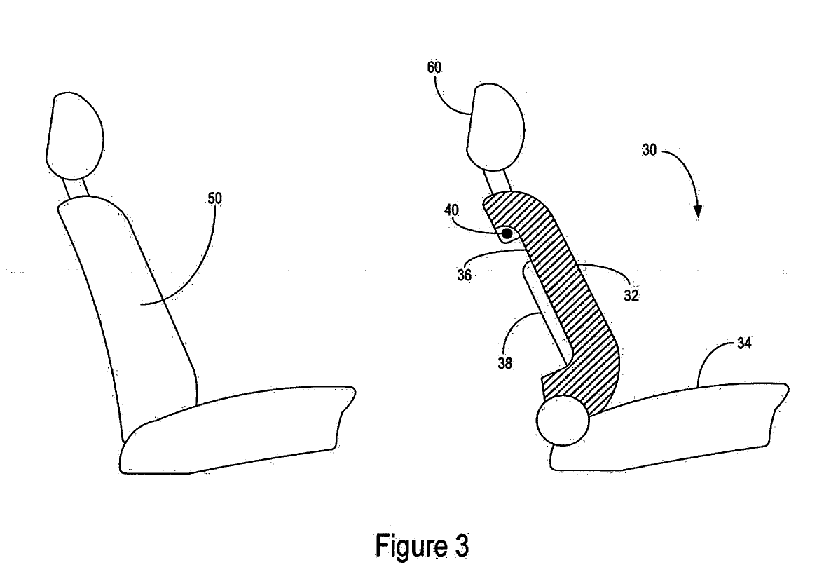

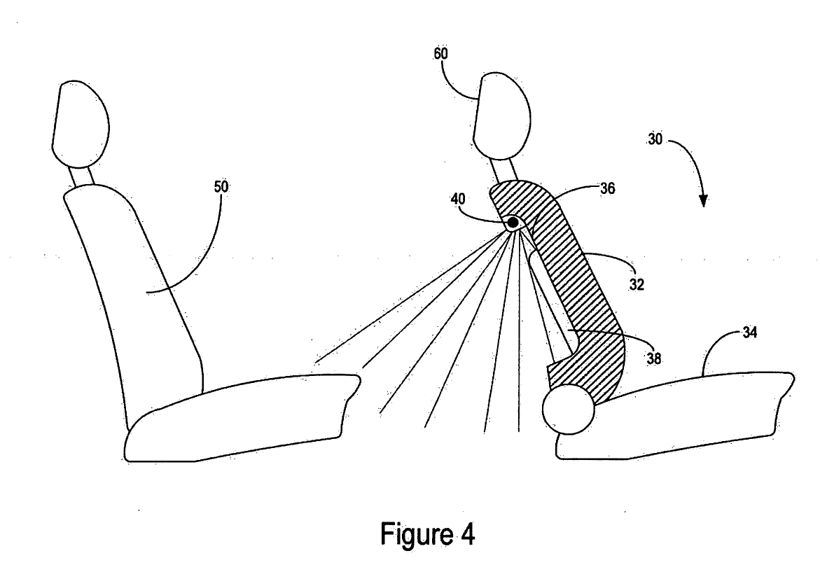

FIGS. 3 and 4 illustrate an exemplary embodiment of the lamp 40 in operation. In FIG. 3, the lamp 40 is off, and in FIG. 4, the lamp 40 is on. The lamp 40 is configured to not obscure the driver if used as a reading lamp while the automobile 10 is in operation. FIG. 4 illustrates the direction of the light from the lamp 40 aimed downward in the rear compartment. The position of the lamp 40 in the carved out portion is such that the emitted light angles downward so as to not obscure the driver.

The lamp 40 can be utilized as a courtesy lamp, a reading lamp, a map pocket lamp, ambience, and the like. For example, the lamp 40 can provide mood lighting, such as a bluish-white hue that highlights the rear seat 50. Further, the lamp 40 can be dimmable as to brighten the automobile 10 rear compartment interior without causing glare or distracting the driver.

The seats 20 and 30 can include wiring for the lamps 40. Advantageously, the lamp 40 of the present invention is low in cost with very little investment to implement. The lamps 40 can be Purchased in Assembly (PIA) with the seats 20 and 30, and there is no additional Hours Per Vehicle (HPV) added to the assembly plant for the lamps 40 if they come in PIA.

The lamp 40 can be placed in the recess portion 36 of both seats backs 22 and 32. Additionally, the lamp 40 can be placed in only one of the seats 20 and 30. For example, the driver's seat 20 can include the recess portion 36 while the passenger's seat 30 does not, with the lamp 40 being located only on the driver's seat 20, and vice versa.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An automobile seat, comprising:
a seat back comprising a recess portion defined within the rear surface of the seat back, wherein the recess portion covers an area that represents the majority of the seat back, and the recess portion extends substantially from the seat back bottom to the seat back top; and
a light attached to a top planar surface of the recess portion.

2. The automobile seat of claim 1, further comprising a pocket disposed within the recess portion.

3. The automobile seat of claim 1, further comprising a switch located on the rear side of the seat back, wherein the switch is configured to turn the light on and off.

4. The automobile seat of claim 1, wherein the light comprises a light emitting diode lamp.

5. The automobile seat of claim 4, wherein the light emitting diode lamp comprises a lens operable to change the color of the light emitting diode lamp.

6. The automobile seat of claim 1, wherein the light comprises one of an incandescent lamp, fluorescent lamp, and light emitting diode lamp.

7. The automobile seat of claim 1, wherein the light is angled substantially downward with respect to the seat back.

8. The automobile seat of claim 1, wherein the light is hard wired into automobile courtesy lamp circuits.

9. The automobile seat of claim 8, wherein the light is dimmable.

10. The automobile seat of claim 1, wherein the light is wired into automobile courtesy lamp circuits with a switchable circuit.

11. The automobile seat of claim 1, wherein the recess portion is formed with a hard plastic shell.

12. An automobile seat light operable for rear compartment lighting, comprising:
a seat back comprising a recess portion defined within the rear surface of the seat back, wherein the recess portion covers an area that represents the majority of the seat back, and the recess portion extends substantially from the seat back bottom to the seat back top; and
a light emitting diode lamp attached to a top planar surface of the recess portion, wherein the lamp is fixed in position inside the recess portion hidden from view, and wherein the lamp comprises a lens operable to change the color of light emitted from the lamp.

13. The automobile seat of claim 12, wherein the light is hard wired into automobile courtesy lamp circuits.

14. The automobile seat of claim 13, wherein the light is dimmable.

15. The automobile seat of claim 12, wherein the light is wired into automobile courtesy lamp circuits with a switchable circuit.

16. The automobile seat of claim 12, wherein the light is angled substantially downward with respect to the seat back.

17. An automobile seat light operable for rear compartment lighting, comprising:
a head rest; and
a light emitting diode lamp attached disposed within the head erst and angled downward to a sent base on a rear seat, wherein the lamp is fixed in position, and wherein the lamp comprises a lens operable to change the color of light emitted from the lamp.
